(19) United States
(12) Patent Application Publication
(10) Pub. No.: US 2009/0117517 A1
(43) Pub. Date: May 7, 2009

(54) Dental crown preparation instrument and method for producing same

(76) Inventor: Andreas Koster, Lemgo (DE)

Correspondence Address: BLISS MCGLYNN, P.C., 2075 WEST BIG BEAVER ROAD, SUITE 600, TROY, MI, 48084, US

(21) Appl. No.: 11/981,925

(22) Filed: Nov. 1, 2007

(51) Int. Cl. A61C 3/02

(52) U.S. Cl. 433/166

(57) ABSTRACT

A dental crown preparation instrument and method for producing same includes a first body produced by grinding, the first body having a substantially cylindrical shaft and a head connected to the shaft, the first body having outer dimensions being substantially equal to the finished preparation instrument, wherein a basic toothing is at first produced in the head by grinding and a secondary toothing is produced subsequently by grinding, wherein a cutting rate of 15 to 40 m/sec is selected for the grinding process, wherein the grinding wheel is moved with a feed rate of 10 to 50 mm/min and the grinding wheels have diamond particles and have a grain size of 15 to 62 μm, and wherein the toothings have cutting edges featuring a surface roughness of not more than 2.5 μm.

### BACKGROUND OF THE INVENTION

1. Field of the Invention

The present invention relates to a dental drill having a shaft, the distal free end of which is provided with a head comprising cutting edges.

2. Description of the Related Art

From the state of the art, dental drills are known in which at least the head consists of a hard metal. Such dental drills or dental crown preparation instruments have to be provided with a specific toothing in order to prepare a dental crown.

### SUMMARY OF THE INVENTION

It is an object of the present invention to provide a dental crown preparation instrument having efficient cutting edges.

It is another object of the present invention to enhance the cutting quality, geometry and/or stableness of the cutting edges for such an instrument.

It is a further object of the present invention to provide a method for producing such a dental crown preparation instrument.

According to the present invention, a dental crown preparation instrument is provided, in which a first body is produced by grinding, the first body comprising a substantially cylindrical shaft as well as a head connected to the shaft, the first body having outer dimensions being substantially equal to the finished preparation instrument, wherein a basic toothing is at first produced in the head by grinding and a secondary toothing is produced subsequently by grinding, wherein a cutting rate of 15 to 40 m/sec is selected for the grinding process, wherein the grinding wheel is moved with a feed rate of 10 to 50 mm/min and the grinding wheels comprise diamond particles and a grain size of 15 to 62 μm, wherein the basic toothing as well as the secondary toothing has cutting edges featuring a surface roughness of not more than 2.5 μm.

It is particularly advantageous if the cutting rate of the grinding wheel is selected such that same ranges between 15 and 40 m/sec. A preferred value lies at 30 m/sec.

According to the present invention, it may be preferred to perform the grinding process by a grinding method in one step or one working step and to produce the grooves required for the formation of the cutting edge in their complete depths. According to the present invention, it is however also possible to use a two-step method and to grind at first e.g. 90% of the depth of the groove and to grind the remaining 10% in a second step of the grinding process. In a preferred further development of the present invention, the second step of the procedure may be performed with a finer grinding wheel and a smaller grain size.

The inventive toothing is preferably produced with a deep grinding method by grinding machines having 5 or 6 axes. Therewith, it is possible to process the clamped first body with two or three grinding wheels by a grinding machine. According to the present invention, it is however also possible to perform the individual grinding steps successively with different grinding machines comprising respectively one grinding wheel.

With a dental crown preparation instrument of the inventive kind, there result considerable advantages due to the selected manufacturing of the cutting edges, since the cutting edges feature a good sharpness which enables to remove the dental enamel during a crown preparation of a tooth efficiently, in a short time and therewith economically, while providing a high surface quality of the prepared snag.

The cutting edge produced according to the present invention also provides a slight chipping in addition to the aforementioned sharpness. The chipping may be measured by the value of the surface roughness of a cutting edge. The surface roughness of the inventive cutting edges effective during the preparation is not larger than 2.5 μm. According to the present invention, it is possible to produce cutting edges having a surface roughness of 1.0 μm, which feature a particularly large sharpness, a particularly high efficiency and a particularly good surface quality.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a schematic lateral view of a first embodiment of a dental crown preparation instrument according to the present invention.

FIG. 2 is a front view in direction of arrow Z of FIG. 1.

FIG. 3 is shows views of different processing steps, starting from the first cylindrical bland to the finished dental crown preparation instrument, according to a further embodiment of the present invention.

FIG. 4 is a schematic view of the grinding method for the basic toothing (main cutting edges).

FIG. 5 is a view, analogous to FIG. 4, of the grinding process for the secondary toothing for generating the secondary cutting edges for a cross toothing.

FIGS. 6a through 6i illustrate different shapes of further embodiments of the present invention in a schematic illustration, analogous to FIG. 1.

FIG. 7 is a schematic view of the use of an inventive embodiment of a dental crown preparation instrument for preparing a snag.

### DESCRIPTION OF THE PREFERRED EMBODIMENT(S)

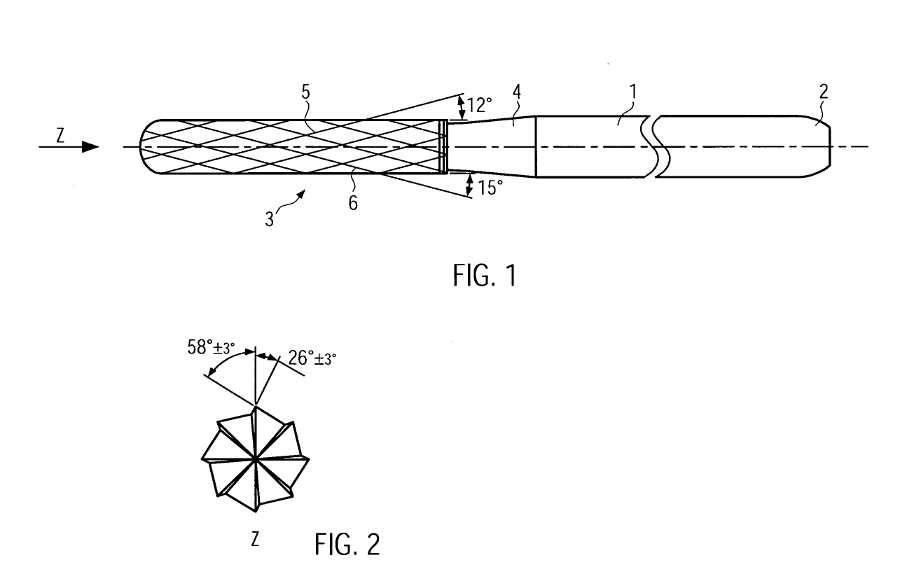

Referring now to the drawings, and in particular FIG. 1, one embodiment of a dental crown preparation instrument, according to the present invention, is shown. The dental crown preparation instrument includes a cylindrical shaft 1, the free end portion 2 of which is provided with a coupling mechanism for clamping same into a drive unit, the mechanism not being shown in detail and known from the state of the art. The dental crown preparation instrument further includes a head 3 which is integrally connected to the cylindrical shaft 1, wherein a transition region 4 of the shaft 1 is formed conically.

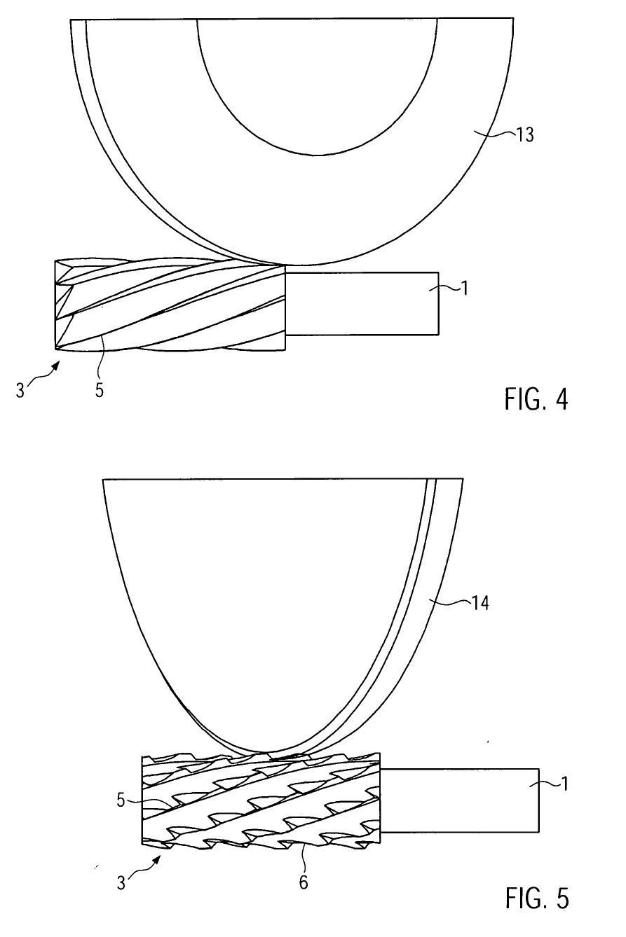

The head 3 comprises a basic toothing 5 for forming main cutting edges (see also FIG. 4) as well as a secondary toothing 6 which is formed as a cross toothing and comprises cross cutting edges.

The front view of FIG. 2 shows that the main cutting edges of the basic toothing 5 are distributed equally about the periphery and have a leading edge angle of 58° and a cutting angle of 26°. According to the present invention, the angles of the embodiment shown in FIGS. 1 and 2 may be larger or smaller by respectively 3°.

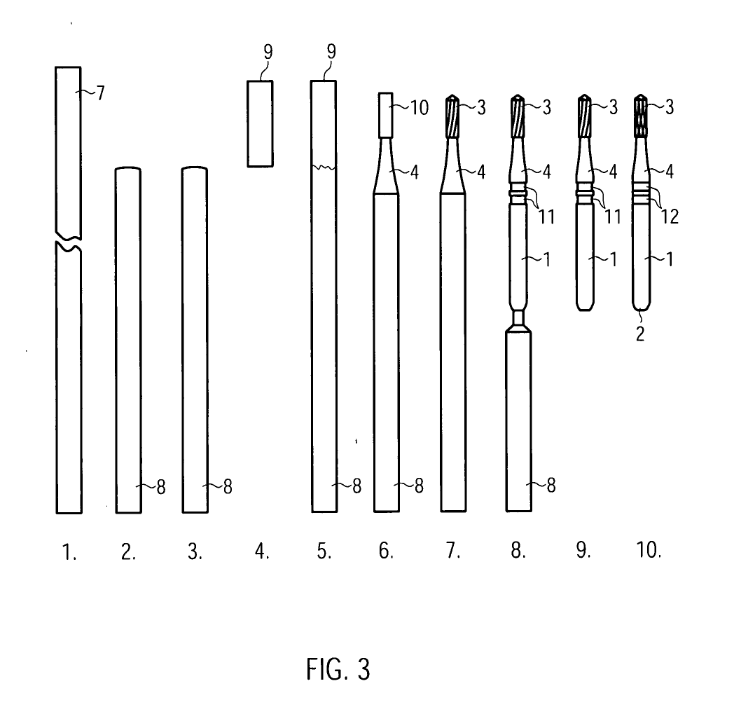

FIG. 3 shows a schematic illustration of the individual processing steps, starting from the blank to the finished dental crown preparation instrument. In the first step, a cylindrical blank is shown, which is, for example, made of steel. In step 2 of FIG. 3, the steel shaft is lathed, while it is tempered in step 3, preferable at its free end portion. The steel shaft 8 is longer than the shaft 1 of the finished dental crown preparation instrument. In step 4, a hard metal blank 9 is shown in its cylindrical shape, the blank being connected to the steel shaft 8 in step 5, for example, by soldering or welding. In step 9, the first body 10 is produced, which already corresponds to the finished head 3 of the dental crown preparation instrument as regards its dimensions. Also the transition region 4 is processed that far, whereas the steel shaft 8 still has a larger diameter and a longer length than the finished shaft 1. In step 7, the toothing is ground analogous to the depiction of FIGS. 4 and 5, in order to produce the basic toothing 5 and the secondary toothing 6 of the head 3. In step 8, the pre-grinding of the shaft 1 is performed. In step 9, the remaining end of the steel shaft 8 is separated from the shaft 1. Furthermore, the shaft 1 is finished by grinding. In step 8, grooves 11 are additionally cut into the shaft 1, the grooves being filled with coloured markings 12 in step 10. In step 10, the surface of the finished dental crown preparation instrument is furthermore polished and cleaned.

FIGS. 4 and 5 show the formation of the cutting edges (toothings). According to FIG. 4, the basic toothing 5 with the main cutting edges is produced by a first grinding wheel 13. According to FIG. 5, the secondary toothing (cross toothing/cross cutting edge) is produced by a second grinding wheel 14. The grinding steps described in FIGS. 4 and 5 are performed according to the parameters described above and defined in the patent claims.

FIGS. 4 and 5 show the production of the cross toothing of the head 3. The basic toothing 5 therein comprises, for example, eight cutting edges (see also FIG. 2) which have a twisting angle of 12°. The secondary toothing 6 comprises e.g. seven cutting edges having twisting angle of 15°. It should be appreciated that a coolant and/or a lubricant may be supplied for the grinding process shown in FIGS. 4 and 5.

The grinding wheels 13 and 14 comprise a border area or a surface area being interspersed with diamond grains. The bonding of the grinding wheels may be a metal bonding, a plastics bonding, or a ceramic bonding. The diamond grinding grains of the diamond grinding wheels 13, 14 have a grain size between 15 and 62 μm. The preferred grain size is 30 μm.

The grinding wheels 13 and 14 are moved with a feed rate between 10 and 50 mm/min. The preferred feed rate is 30 mm/min.

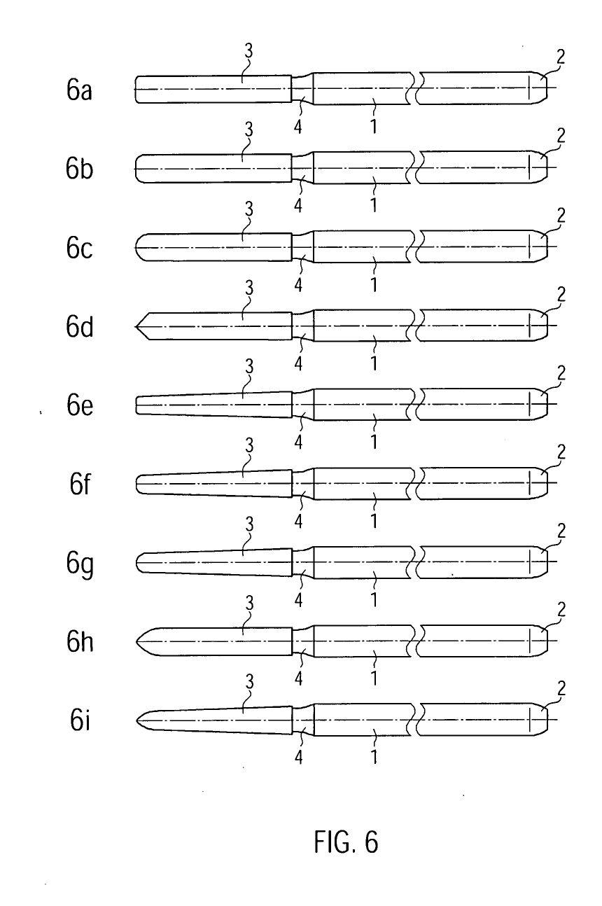

FIG. 6 shows in its sections 6a to 6i different shapes of preferred embodiments of the present invention featuring different geometries of the head 3. Therein, the head is shaped cylindrically and at its end respectively flat, slightly rounded, semi-spherical, or acute in the illustrations 6a to 6d. According to the embodiments of FIGS. 6e to 6g, the head 3 is shaped conically and at its end respectively flat, slightly rounded or semi-spherically rounded. FIG. 6h shows a cylindrical head 3 having a rounded tip, whereas FIG. 6i shows a conical basic shape having a rounded tip.

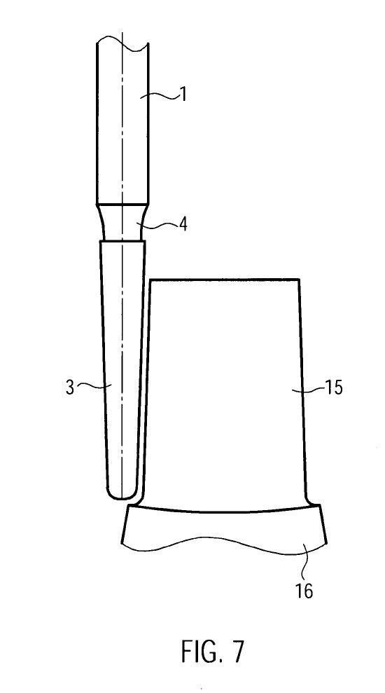

FIG. 7 shows the use of the inventive dental crown preparation instrument for preparing a snag 15 for subsequently attaching a crown (not shown) as well as a tooth neck 16 in schematic depiction.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. A dental crown preparation instrument comprising:
a first body produced by grinding, said first body comprising a substantially cylindrical shaft and a head connected to said shaft, said first body having outer dimensions being substantially equal to the finished preparation instrument;
wherein a basic toothing is at first produced in the head by grinding and a secondary toothing is produced subsequently by grinding, wherein a cutting rate of 15 to 40 m/sec is selected for the grinding process, wherein the grinding wheel is moved with a feed rate of 10 to 50 mm/min and the grinding wheels comprise diamond particles and have a grain size of 15 to 62 μm; and
wherein the toothings have cutting edges featuring a surface roughness of not more than 2.5 μm.

2. A dental crown preparation instrument as set forth in claim 1 wherein the cutting rate is 30 m/sec.

3. A dental crown preparation instrument as set forth in claim 1 wherein the feed rate is 30 mm/min.

4. A dental crown preparation instrument as set forth in claim 1 wherein the grain size of the grinding wheels is 30 μm.

5. A dental crown preparation instrument as set forth in claim 1 wherein the surface roughness of the cutting edges of the basic toothing and the secondary toothing is 1.0 μm.

6. A dental crown preparation instrument as set forth in claim 1 wherein a cylindrical steel blank is mechanically processed at first and subsequently tempered, and subsequently a cylindrical hard metal blank is connected to the steel blank.

7. A dental crown preparation instrument as set forth in claim 6 wherein the connection of the steel blank and the hard metal blank is achieved by soldering.

8. A dental crown preparation instrument as set forth in claim 6 wherein the connection of the steel blank and the hard metal blank is achieved by welding.

9. A dental crown preparation instrument as set forth in claim 1 wherein the first body is produced integrally from a hard metal material.

10. A dental crown preparation instrument as set forth in claim 1 wherein the grinding process for the basic toothing and/or the secondary toothing is respectively performed in one grinding step.

11. A dental crown preparation instrument as set forth in claim 1 wherein the grinding process for the basic toothing and the secondary toothing is respectively performed in two successive grinding steps.

12. A dental crown preparation instrument as set forth in claim 11 wherein 90% of the groove depth is produced in a first grinding step and 10% of the groove depth is produced in a second step for generating the basic toothing and/or the secondary toothing.

13. A dental crown preparation instrument as set forth in claim 1 wherein the basic toothing is provided with eight main cutting edges.

14. A dental crown preparation instrument as set forth in claim 13 wherein the basic toothing has a twisting angle of 12°.

15. A dental crown preparation instrument as set forth in claim 1 wherein the secondary toothing is provided with seven cutting edges.

16. A dental crown preparation instrument as set forth in claim 15 wherein the secondary toothing has a twisting angle of 15°.

17. A dental crown preparation instrument as set forth in claim 1 wherein the head has a cylindrical basic shape.

18. A dental crown preparation instrument as set forth in claim 1 wherein the head has a conical basic shape.

19. A method for producing a dental crown preparation instrument, said method comprising the steps of:
grinding a first body, the first body comprising a substantially cylindrical shaft and a head connected to the shaft, the first body having outer dimensions being substantially equal to the finished preparation instrument;
wherein a basic toothing is at first produced in the head by grinding and a secondary toothing is produced subsequently by grinding, wherein a cutting rate of 15 to 40 m/sec is selected for the grinding process, wherein the grinding wheel is moved with a feed rate of 10 to 50 mm/min and wherein the grinding wheels comprise diamond particles and have a grain size of 15 to 62 μm; and
wherein the toothings have cutting edges featuring a surface roughness of not more than 2.5 μm.

20. A method as set forth in claim 19 wherein the cutting rate is 30 m/sec.

21. A method as set forth in claim 19 wherein the feed rate is 30 mm/min.

22. A method as set forth in claim 19 wherein the grain size of the grinding wheels is 30 μm.

23. A method as set forth in claim 19 wherein the surface roughness of the cutting edges of the basic toothing and the secondary toothing is 1.0 μm.
